(19) United States
(12) Patent Application Publication
(10) Pub. No.: US 2024/0374940 A1
(43) Pub. Date: Nov. 14, 2024

(54) METHOD FOR MANUFACTURING SHOCKABSORBING LANYARD FOR EASY LENGTH ADJUSTMENT OF POY

(71) Applicant: EASTERN INDUSTRIAL CORP, Seoul (KR)

(72) Inventors: Jun Young PARK, Gyeonggi-do (KR); Ki Young KIM, Seoul (KR)

(73) Assignee: EASTERN INDUSTRIAL CORP, Seoul (KR)

(21) Appl. No.: 18/256,613

(22) PCT Filed: May 12, 2023
(86) PCT No.: PCT/KR2023/006508

§ 371 Date: Jun. 8, 2023

(30) Foreign Application Priority Data
Jun. 14, 2022 (KR) 10-2022-0071874

(51) Int. Cl. A62B 35/00; A62B 35/04; D03D 3/02; D03D 15/56

(52) U.S. Cl. CPC A62B 35/0043; A62B 35/04; D03D 3/02; D03D 15/56

(57) ABSTRACT

Disclosed is a method for manufacturing a shock-absorbing lanyard for easy length adjustment of partially oriented yarn (POY). The method for manufacturing a shock-absorbing lanyard for easy length adjustment of POY according to the present disclosure includes (a) weaving a safety tube band which is a tube fabric woven using fiber yarn and rubber yarn, and placing a core material in the safety tube band at the same time, wherein the core material is made of a plurality of POY and stretches in a longitudinal direction to absorb shock; (b) adjusting a length of the core material after weaving the safety tube band; and (c) combining the safety tube band with the core material to form a combination.

### BACKGROUND

### 1. Field

The present disclosure relates to a method for manufacturing a shock-absorbing lanyard for easy length adjustment of partially oriented yarn (POY).

### 2. Description of the Related Art

In general, when workers perform tasks in structures installed at heights from the ground, for example, construction sites of high-rise structures such as buildings or bridges, shipyards where large ships are built, and places where repair and maintenance tasks of utility poles or steel pole towers are performed or the like, the workers are required to wear safety personal protective equipment such as safety belts and safety helmets to protect them from danger such as fall accidents in the workplace.

A safety belt for working at height is designed such that clasp-shaped hooks connected to a shock-absorbing lanyard are securely attached to a safety harness and an anchorage, and shock absorbers of various shapes are installed in the shock-absorbing lanyard to absorb and mitigate strong shocks applied to a worker in case of a falls.

In the existing shock-absorbing lanyard, a braided rope of natural fibers and yarns is connected to the worker at one end and securely attached to the anchorage at the other end to prevent the worker from falling while working at height. However, the existing shock-absorbing lanyard is long in length and the slack in the lanyard impedes the worker's activities, and when a fall occurs, strong loads are directly applied to the worker, causing injury to the worker.

To solve these problems, Korean Patent No. 10-1510537 discloses a safety rope fabric for use in a safety belt for working at height, woven by double weave, including an elastic portion and a woven portion made of synthetic yarns, wherein a plurality of synthetic yarns as weft and warp yarns are woven by double weave to produce a tube fabric of a tubular shape, and a partially oriented yarn (POY) band is embedded in the tube fabric to provide elasticity.

That is, the weft and warp yarns of synthetic fibers are woven to produce the tube fabric, the POY band is woven and inserted into the tube fabric, and then the tube fabric and the POY band are combined together by sewing. Accordingly, since each of the tube fabric and the POY band is woven and then the POY band is inserted into the tube fabric, the productivity loss increases and the work efficiency decreases.

### RELATED LITERATURES

### Patent Literature

Korean Patent No. 10-1510537 (published Apr. 8, 2015)

### SUMMARY

Accordingly, the present disclosure is directed to providing a method for manufacturing a shock-absorbing lanyard for easy length adjustment of partially oriented yarn (POY), whereby the work procedure is simplified, the work efficiency is enhanced and it is easy to meet a variety of safety standards.

According to an aspect of the present disclosure, there is provided a method for manufacturing a shock-absorbing lanyard for easy length adjustment of POY, including (a) weaving a safety tube band which is a tube fabric woven using fiber yarn and rubber yarn, and placing a core material in the safety tube band at the same time, wherein the core material is made of a plurality of POY and stretches in a longitudinal direction to absorb shock; (b) adjusting a length of the core material after weaving the safety tube band; and (c) combining the safety tube band with the core material to form a combination.

The safety tube band may include a first end portion which is the tube fabric produced by weaving the fiber yarn and the rubber yarn as warp and the fiber yarn as weft and is flat in the longitudinal direction; a central portion which is the tube fabric produced by weaving the fiber yarn as warp and weft and the rubber yarn as warp woven with the fiber yarn and as core yarn woven without the fiber yarn, repeatedly arranged at a predetermined interval, and is extended from the first end portion and corrugated in the longitudinal direction; and a second end portion which is the tube fabric produced by weaving the fiber yarn and the rubber yarn as warp and the fiber yarn as weft, and is extended from the central portion and flat in the longitudinal direction, and the step (a) may include continuously weaving the first end portion, the central portion and the second end portion of the safety tube band in a sequential order.

The rubber yarn which forms the central portion of the safety tube band may include first rubber yarn as warp which is woven over a plurality of the fiber yarns as weft disposed and continuously arranged in an upper fabric of the tube fabric which forms the safety tube band and interposed between the upper fabric and a lower fabric of the tube fabric which forms the safety tube band to a predetermined distance, wherein this process is repeatedly performed; and second rubber yarn as warp which is woven under the plurality of fiber yarns as weft disposed and continuously arranged in the lower fabric of the tube fabric which forms the safety tube band and interposed between the upper fabric and the lower fabric of the tube fabric which forms the safety tube band to the predetermined distance, wherein this process is repeatedly performed.

The first rubber yarn may be woven over two to four fiber yarns as weft, and the second rubber yarn may be woven under two or four fiber yarns as weft.

Three to eight fiber yarns arranged in parallel in the longitudinal direction may form a set of fiber yarns, and one or two first rubber yarns or second rubber yarns may be repeatedly arranged in parallel between the sets of fiber yarns.

The first rubber yarn and the second rubber yarn may be the core yarn interposed between the upper fabric and the lower fabric to the distance corresponding to an interval between ten to fifteen fiber yarns as weft.

A first position and a second position may repeat in an alternating manner along the longitudinal direction, the first position at which the first rubber yarn is woven over the plurality of fiber yarns as weft disposed in the upper fabric, and the second position at which the second rubber yarn is woven under the plurality of fiber yarns as weft disposed in the lower fabric.

The first end portion and the second end portion of the safety tube band may be flat woven by repeatedly weaving the first rubber yarn which forms the upper fabric with the fiber yarn as weft disposed in the upper fabric in an alternating manner, and extending the second rubber yarn which forms the lower fabric and repeatedly weaving the second rubber yarn with the fiber yarn as weft disposed in the lower fabric in an alternating manner.

The step (a) may include weaving a first end portion of the plurality of POY of the core material with the first end portion of the safety tube band, and continuously weaving the central portion and the second end portion of the safety tube band in a sequential order, wherein the plurality of POY is arranged in parallel in the longitudinal direction inside the central portion and the second end portion of the safety tube band, and an end of a second end portion of the plurality of POY is disposed outside of the second end portion of the safety tube band.

The step (b) may include pulling the end of the second end portion of the plurality of POY out of the second end portion of the safety tube band, and cutting the second end portion of the plurality of POY so that a length of the safety tube band is longer than a total stretched length of the plurality of POY.

The step (c) may include sewing the second end portion of the safety tube band and the second end portion of the plurality of POY to form the combination.

According to an embodiment of the present disclosure, since placing the core material made of a plurality of POY in the safety tube band while weaving the safety tube band is performed, it is possible to eliminate the tedious tasks of separately weaving the safety tube band and the core material and inserting the core material into the safety tube band, thereby reducing the time to complete the tasks and making the work procedure easy and convenient, resulting in improved work efficiency.

Additionally, according to an embodiment of the present disclosure, it is easy to adjust the length of POY of which the core material is made, and it is possible to meet a variety of safety standards from all over the world.

### BRIEF DESCRIPTION OF THE DRAWINGS

FIG. 1 is a perspective view showing a shock-absorbing lanyard according to the present disclosure.

FIG. 2 is a side cross-sectional view showing a shock-absorbing lanyard according to the present disclosure.

FIG. 3 is a partial cut-away view showing a shock-absorbing lanyard according to the present disclosure.

FIG. 4 is a deployment view showing an interlaced structure of a central portion of a safety tube band according to the present disclosure.

FIG. 5 is a weave diagram showing an interlaced structure of a central portion of a safety tube band according to the present disclosure.

FIG. 6 is a weave diagram showing an interlaced structure of a first end portion of a safety tube band according to the present disclosure.

FIG. 7 is a weave diagram showing an interlaced structure of a second end portion of a safety tube band according to the present disclosure.

FIGS. 8 to 10 are operational diagrams showing the operation of a shock-absorbing lanyard according to the present disclosure.

### DETAILED DESCRIPTION

To understand the present disclosure, advantages of the operation of the present disclosure and objectives achieved by the embodiment of the present disclosure, reference should be made to the accompanying drawings illustrating an exemplary embodiment of the present disclosure and the description in the accompanying drawings.

Hereinafter, the present disclosure will be described in detail by describing an exemplary embodiment of the present disclosure with reference to the accompanying drawings. In each drawing, like reference numerals denote like elements.

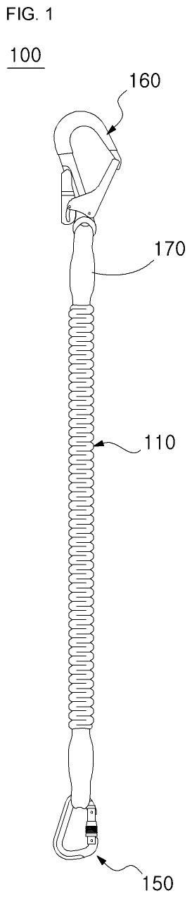

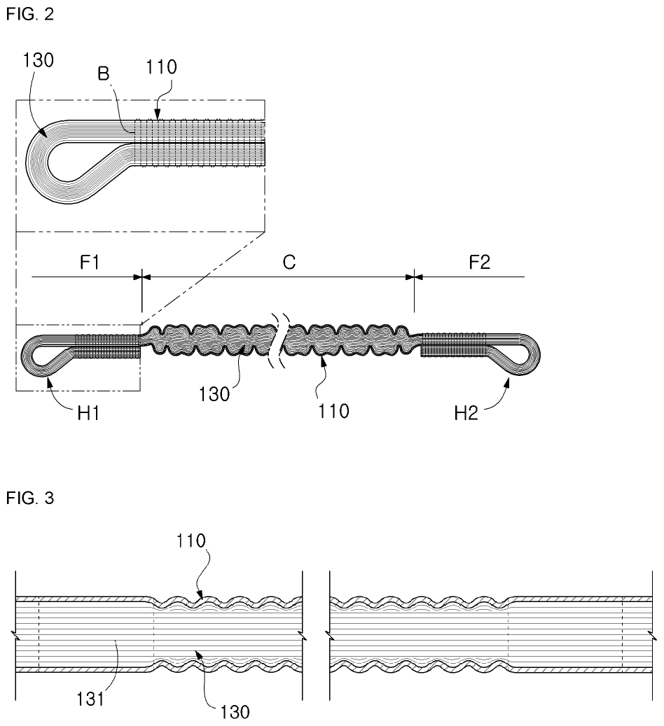

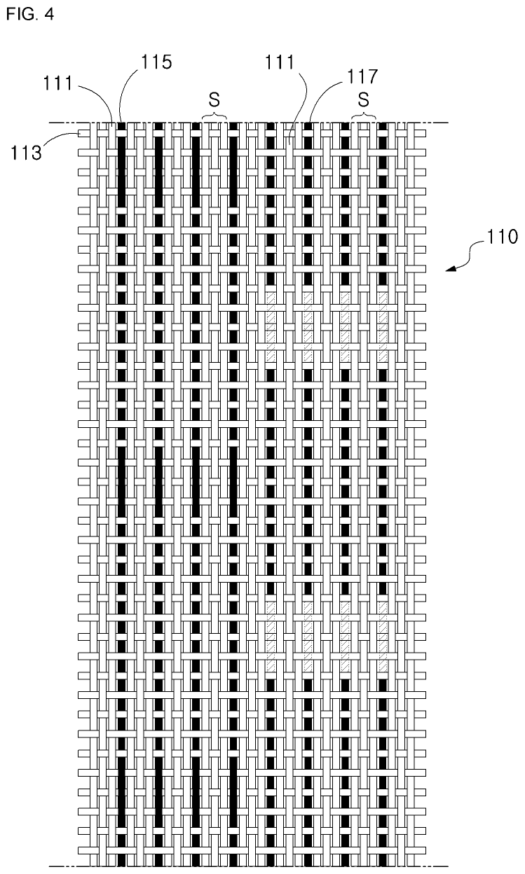

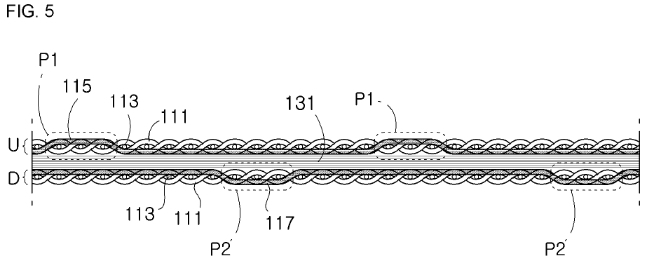

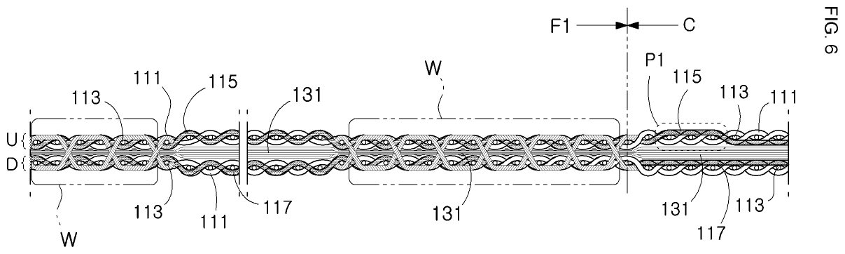

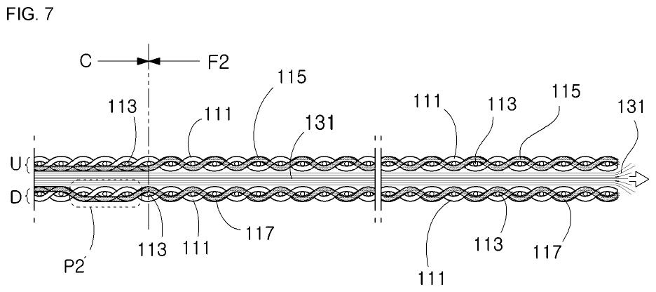

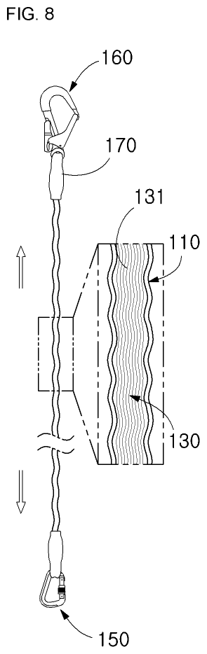

FIG. 1 is a perspective view showing a shock-absorbing lanyard according to the present disclosure, FIG. 2 is a side cross-sectional view showing the shock-absorbing lanyard according to the present disclosure, FIG. 3 is a partial cut-away view showing the shock-absorbing lanyard according to the present disclosure, FIG. 4 is a deployment view showing an interlaced structure of a central portion of a safety tube band according to the present disclosure, FIG. 5 is a weave diagram showing the interlaced structure of the central portion of the safety tube band according to the present disclosure, FIG. 6 is a weave diagram showing an interlaced structure of a first end portion of the safety tube band according to the present disclosure, FIG. 7 is a weave diagram showing an interlaced structure of a second end portion of the safety tube band according to the present disclosure, and FIGS. 8 to 10 are operational diagrams showing the operation of the shock-absorbing lanyard according to the present disclosure.

Referring to FIGS. 1 to 7, the shock-absorbing lanyard 100 according to the present disclosure includes a combination of a core material 130 and a safety tube band 110, wherein the core material 130 is made of a plurality of partially oriented yarn (POY) 131 and stretches to absorb shocks when shock loads are transmitted, and the safety tube band 110 prevents a worker from falling when the core material 130 is broken by the shocks, a carabiner to which a first end portion F1 of the combination is attached, and a hook which is attached to a second end portion F2 of the combination.

In general, when working at height, the worker wears an industrial safety swing, and the shock-absorbing lanyard 100 is connected to the industrial safety swing. Additionally, in case of a fall, when the worker's weight is applied, the core material 130 stretches to absorb shocks, and when the core material 130 is broken, the safety tube band 110 prevents the worker from falling.

In this embodiment, the first end portion F1 of the combination where two end portions of the core material 130 are combined with two end portions of the safety tube band 110 is folded and sewn B to form a carabiner hoop H1 which is attached to the carabiner 150. The carabiner 150 is connected to a waist belt of the industrial safety swing or a swing hanger at the worker's back. Although this embodiment shows the carabiner hoop H1 at the first end portion F1 of the combination and a hook loop H2 at the second end portion F2 of the combination, on the contrary, the hook loop H2 may be disposed at the first end portion F1 of the combination and the carabiner hoop H1 may be disposed at the second end portion F2 of the combination.

Additionally, in this embodiment, the second end portion F2 of the combination is folded and sewn B to form the hook loop H2 which is attached to the hook 160. The hook 160 is securely attached to an anchorage to prevent the worker from falling while working at height.

Additionally, the carabiner hoop H1 and the hook loop H2 are covered with a protective cover 170 to prevent the exposure of the carabiner hoop H1 and the hook loop H2 when attached to the carabiner 150 and the hook 160 (see FIG. 1).

As described above, in this embodiment, the core material 130 and the safety tube band 110 are combined together to absorb shocks and prevent falls when shock loads are transmitted (see FIGS. 2 and 3). The core material 130 is disposed inside the safety tube band 110, and the two end portions of the core material 130 are combined with the two end portions of the safety tube band 110.

The core material 130 is made of a plurality of POY 131 arranged in parallel in the longitudinal direction, not woven together. The POY 131 or non-stretchable yarn stretches in the longitudinal direction when strong forces are applied. The POY 131 of the core material 130 may have an elongation of about 100%. That is, the total stretched length of the core material 130 by shock loads may approximately double the initial length. Accordingly, the plurality of POY 131 of the core material 130 stretches by shock loads applied to the worker in case of a fall, so as to mitigate and absorb the strong shocks applied to the worker.

The safety tube band 110 is a high tenacity fabric created by weaving fiber yarn and rubber yarns 115, 117 into a tube fabric, and does not break even when the core material 130 is broken by shock loads in order to prevent the worker from falling. The fiber yarn is produced from synthetic fibers of polyester, high density polyethylene, aramid, polyacrylate or the like.

The safety tube band 110 includes the first end portion F1 which is the tube fabric produced by weaving the fiber yarn and the rubber yarns 115, 117 as warp and the fiber yarn as weft and is flat in the longitudinal direction, a central portion C which is the tube fabric produced by weaving the fiber yarn as warp and weft and the rubber yarns 115, 117 as warp woven with the fiber yarn and as core yarn woven without the fiber yarn, repeatedly arranged at a predetermined interval, and is extended from the first end portion F1 and corrugated in the longitudinal direction, and the second end portion F2 which is the tube fabric produced by weaving the fiber yarn and the rubber yarns 115, 117 as warp and the fiber yarn as weft and is extended from the central portion C and flat in the longitudinal direction. The safety tube band 110 is the tube fabric produced by continuously weaving the first end portion F1, the central portion C and the second end portion F2 in a sequential order.

As described above, the central portion C of the safety tube band 110 is the tube fabric which is corrugated in the longitudinal direction, and the first end portion F1 and the second end portion F2 extended from the two sides of the central portion C of the safety tube band 110 are the tube fabric which is flat in the longitudinal direction. As the central portion C of the safety tube band 110 is formed in a corrugated shape, the central portion C of the core material 130 disposed inside the safety tube band 110 may have a corrugated shape.

The length of the safety tube band 110 may be longer than the total stretched length of the core material 130 by shock loads. For example, the length of the safety tube band 110 may be about 10% longer than the total stretched length of the core material 130.

In this embodiment, in forming the combination, placing the core material 130 in the safety tube band 110 while weaving the safety tube band 110 is performed, so it is possible to reduce the time to complete the task, thereby improving the work efficiency. The combination of the safety tube band 110 and the core material 130 is made by the following process.

The first end portion F1 of the safety tube band 110 is woven with the first end portion F1 of the core material 130 made of the plurality of POY 131. This is to secure the first end portion F1 of the plurality of POY 131 of the core material 130 to the first end portion F1 of the safety tube band 110 in order to prevent the plurality of POY 131 of the core material 130 from escaping from the safety tube band 110.

A weaving region W at which the first end portion F1 of the safety tube band 110 is woven with and the first end portion F1 of the core material 130 may be the sum of the first end portion F1 of the safety tube band 110 and the first end portion F1 of the core material 130, but a plurality of weaving regions W may be spaced a predetermined distance apart from each other at the first end portion F1 of the safety tube band 110 and the first end portion F1 of the core material 130 (see FIG. 6). When the first end portion F1 of the safety tube band 110 and the first end portion F1 of the core material 130 are spaced the predetermined distance apart from each other, the weaving region W may be preferably present in the area at which the first end portion F1 of the combination is folded and sewn B. That is, the weaving region W may be present in the area adjacent to the end of the first end portion F1 of the safety tube band 110 and before the start of the central portion C of the safety tube band 110.

Additionally, the central portion C and the second end portion F2 of the safety tube band 110 are continuously woven in a sequential order to produce the tube fabric. In this instance, the plurality of POY 131 of the core material 130 is arranged in parallel in the longitudinal direction inside the central portion C and the second end portion F2 of the safety tube band 110 (see FIGS. 6 and 7).

When the central portion C and the second end portion F2 of the safety tube band 110 are woven in a sequential order, the second end portion F2 of the core material 130 protrudes out of the second end portion F2 of the safety tube band 110 (see FIG. 7).

Additionally, the end of the second end portion F2 of the plurality of POY 131 is pulled out of the second end portion F2 of the safety tube band 110 to a predetermined length so that the length of the safety tube band 110 is longer than the total stretched length of the plurality of POY 131 (see FIG. 7). Additionally, the length of the plurality of POY 131 is adjusted to meet a variety of safety standards from all over the world, and the second end portion F2 of the plurality of POY 131 is cut.

Additionally, the second end portion F2 of the safety tube band 110 and the second end portion F2 of the plurality of POY 131 are combined together by sewing them.

A method for making the combination according to this embodiment will be described in detail with reference to FIGS. 4 to 7 below.

In the case where the worker uses the shock-absorbing lanyard 100 connected to the industrial safety swing when working, when the shock-absorbing lanyard 100 is long in length, it may impede the worker's activities, resulting in low work efficiency. To improve convenience for the worker at work, the central portion C of the safety tube band 110 disposed at the outer side of the combination is corrugated. That is, as the central portion C of the safety tube band 110 is corrugated, it is possible to freely change the length, thereby improving convenience for the worker at areas of activities, and prevent the combination from being unnecessarily suspended when not working or while working at height.

Referring to FIGS. 4 and 5, a process of weaving the central portion C of the safety tube band 110 using the fiber yarn and the rubber yarns 115, 117 will be described below.

As shown in FIG. 4, the tube fabric of the central portion C of the safety tube band 110 is made of first fiber yarn 111 as warp and second fiber yarn 113 as weft. Additionally, the rubber yarns 115, 117 are arranged spaced apart from each other between the first fiber yarns 111 as warp.

When three to eight first fiber yarns 111 arranged in parallel in the longitudinal direction form a set of fiber yarns S in this embodiment, one or two rubber yarns 115, 117 are repeatedly arranged in parallel between the sets of fiber yarns S. Preferably, three first fiber yarns 111 form a set of fiber yarns S and one rubber yarn 115, 117 is repeatedly arranged in parallel between the sets of fiber yarns S.

When less than three first fiber yarns 111 form a set of fiber yarns S and the rubber yarns 115, 117 are repeatedly arranged between the sets of fiber yarns S, the tube fabric may be corrugated too much, and when more than eight first fiber yarns 111 form a set of fiber yarns S and the rubber yarns 115, 117 are repeatedly arranged between the sets of fiber yarns S, the tube fabric may not be corrugated.

The tube fabric of the central portion C of the safety tube band 110 is formed by weaving the first fiber yarn 111 as warp and the second fiber yarn 113 as weft together with the rubber yarns 115, 117. In this instance, the process of weaving the rubber yarns 115, 117 with or without the second fiber yarn 113 as weft is repeatedly performed. That is, when the rubber yarns 115, 117 are woven with the second fiber yarn 113 as weft, the rubber yarns 115, 117 act as warp, and when the rubber yarns 115, 117 are woven without the second fiber yarn 113, the rubber yarns 115, 117 act as core yarn.

As shown in FIG. 5, the rubber yarns 115, 117 that form the central portion C of the safety tube band 110 include the first rubber yarn 115 as warp which is woven over two to four second fiber yarns 113 as weft disposed and continuously arranged in an upper fabric U of the tube fabric that forms the safety tube band 110 and is interposed as core yarn between the upper fabric U and a lower fabric D that form the safety tube band 110 to the predetermined distance, wherein this process is repeatedly performed, and the second rubber yarn 117 as warp which is woven under two to four second fiber yarns 113 as weft disposed and continuously arranged in the lower fabric D of the tube fabric that forms the safety tube band 110 and is interposed between the upper fabric U and the lower fabric D that form the safety tube band 110 to the predetermined distance, wherein this process is repeatedly performed.

The first rubber yarn 115 and the second rubber yarn 117 are woven with the first fiber yarn 111 as warp and the second fiber yarn 113 as weft by repeating the above-described process to form the corrugated central portion C of the safety tube band 110.

When the first rubber yarn 115 or the second rubber yarn 117 is woven over or under one second fiber yarn 113 as weft, the safety tube band 110 may not be corrugated. Additionally, when the first rubber yarn 115 or the second rubber yarn 117 is woven over or under five or more second fiber yarns 113 as weft, the first rubber yarn 115 or the second rubber yarn 117 may be exposed through the safety tube band 110, and in case where frictional contact with the outside and damage by an external structure occurs, the first rubber yarn 115 or the second rubber yarn 117 may break.

Additionally, the first rubber yarn 115 and the second rubber yarn 117 as core yarn may be interposed between the upper fabric U and the lower fabric D to the predetermined distance corresponding to the interval between ten to fifteen second fiber yarns 113 as weft. The predetermined distance to which the first rubber yarn 115 and the second rubber yarn 117 as core yarn are interposed between the upper fabric U and the lower fabric D may be adjusted, taking into account the minimal length of the shock-absorbing lanyard 100 in terms of worker convenience and stability at work, and the height of the corrugation.

Referring to FIG. 5, in this embodiment, the first rubber yarn 115 is woven over three second fiber yarn 113 as weft disposed in the upper fabric U, and is interposed as core yarn in parallel between the upper fabric U and the lower fabric D to the predetermined distance corresponding to the interval between twelve second fiber yarns 113 as weft.

Additionally, the second rubber yarn 117 is woven under three second fiber yarns 113 as weft disposed in the lower fabric D, and is interposed as core yarn in parallel between the upper fabric U and the lower fabric D to the predetermined distance corresponding to the interval between twelve second fiber yarns 113 as weft.

Additionally, considering corrugation uniformity and aesthetics of the safety tube band 110, a first position P1 and a second position P2 repeat in an alternating manner along the longitudinal direction, the first position P1 at which the first rubber yarn 115 is woven over the plurality of second fiber yarns 113 as weft disposed in the upper fabric U, and the second position P2 at which the second rubber yarn 117 is woven under the plurality of second fiber yarns 113 as weft disposed in the lower fabric D.

As shown in FIG. 5, the second position P2 is disposed between the first positions P1 arranged in a sequential order along the longitudinal direction of the safety tube band 110. Preferably, the second position P2 is disposed in the middle between the neighboring first positions P1 along the longitudinal direction of the safety tube band 110. Meanwhile, the first rubber yarn 115 and the second rubber yarn 117 are woven in 70 to 90% stretched state of the total stretched length.

While the central portion C of the safety tube band 110 is woven as described above, the plurality of POY 131 of the core material 130 is continuously arranged in parallel in the longitudinal direction between the upper fabric U and the lower fabric D of the tube fabric that forms the safety tube band 110.

Additionally, as described above, to prevent the plurality of POY 131 of the core material 130 from escaping from the safety tube band 110, while the first end portion F1 of the safety tube band 110 is woven, the first end portion F1 of the safety tube band 110 and the first end portion F1 of the core material 130 made of the plurality of POY 131 are woven together to secure the first end portion F1 of the plurality of POY 131 to the first end portion F1 of the safety tube band 110.

The first end portion F1 of the safety tube band 110 is woven into the tube fabric and is flat woven. Additionally, the first end portion F1 of the safety tube band 110 is made of the first fiber yarn 111 as warp and the second fiber yarn 113 as weft. Additionally, the rubber yarns 115, 117 are arranged spaced apart from each other between the first fiber yarns 111 as warp. The first fiber yarn 111 and the rubber yarns 115, 117 that form the central portion C and the first end portion F1 of the safety tube band 110 are integrally extended. Accordingly, although not shown, in this embodiment, when three to eight first fiber yarns 111 arranged in parallel form a set of fiber yarns S, one or two rubber yarns 115, 117 may be repeatedly arranged in parallel between the sets of fiber yarns S. Preferably, three first fiber yarns 111 form a set of fiber yarns S and one rubber yarn 115, 117 is repeatedly arranged in parallel between the sets of fiber yarns S.

Additionally, the tube fabric of the first end portion F1 of the safety tube band 110 is formed by weaving the first fiber yarn 111 as warp and the second fiber yarn 113 as weft together with the rubber yarns 115, 117. In this instance, the rubber yarns 115, 117 act as warp which is woven with the second fiber yarn 113 as weft.

As shown in FIG. 6, describing the interlaced structure of the first end portion F1 of the safety tube band 110, the rubber yarns 115, 117 that form the first end portion F1 of the safety tube band 110 include the first rubber yarn 115 as warp which is repeatedly woven with the second fiber yarn 113 as weft disposed in the upper fabric U of the tube fabric that forms the safety tube band 110 in an alternating manner, and the second rubber yarn 117 as warp which is repeatedly woven with the second fiber yarn 113 as weft disposed in the lower fabric D of the tube fabric that forms the safety tube band 110 in an alternating manner. The first rubber yarn 115 and the second rubber yarn 117 are woven with the first fiber yarn 111 and the second fiber yarn 113 by repeating the above-described process to form the flat first end portion F1 of the safety tube band 110. That is, the first rubber yarn 115 that forms the upper fabric U of the tube fabric that forms the safety tube band 110 is extended and repeatedly woven with the second fiber yarn 113 as weft disposed in the upper fabric U in an alternating manner, and the second rubber yarn 117 that forms the lower fabric D of the tube fabric that forms the safety tube band 110 is extended and repeatedly woven with the second fiber yarn 113 as weft disposed in the lower fabric D in an alternating manner. Meanwhile, the first rubber yarn 115 and the second rubber yarn 117 are woven in 70 to 90% stretched state of the total stretched length.

Additionally, while the first end portion F1 of the safety tube band 110 is woven as described above, the core material 130 made of the plurality of POY 131 is disposed inside the first end portion F1 of the safety tube band 110, and the first end portion F1 of the safety tube band 110 is woven with the first end portion F1 of the core material 130 made of the plurality of POY 131. When the first end portion F1 of the safety tube band 110 is woven with the first end portion F1 of the core material 130, the first end portion F1 of the safety tube band 110 and the first end portion F1 of the core material 130 may have the plurality of weaving regions W spaced the predetermined distance apart from each other along the longitudinal direction. When the first end portion F1 of the safety tube band 110 is woven with the first end portion F1 of the core material 130, the first fiber yarn 111 as warp may be used as warp and interlacing yarn. That is, the first end portion F1 of the safety tube band 110 may be woven with the first end portion F1 of the core material 130 by repeatedly weaving the first fiber yarn 111 to produce the upper fabric U and the lower fabric D of the tube fabric that forms the safety tube band 110 in an alternating manner.

Meanwhile, when the weaving of the combination is completed, the first end portion F1 of the combination where the first end portion F1 of the safety tube band 110 is combined with the first end portion F1 of the core material 130 may be folded and sewn B to form the carabiner hoop H1 which is attached to the carabiner 150 (see FIG. 2).

Additionally, as described above, to adjust the length of the core material 130 made of the plurality of POY 131 inside the safety tube band 110 in order to meet a variety of safety standards from all over the world, while the second end portion F2 of the safety tube band 110 is woven, the core material 130 is disposed inside the safety tube band 110, and when the weaving of the second end portion F2 of the safety tube band 110 is completed, the second end portion F2 of the core material 130 protrudes out of the second end portion F2 of the safety tube band 110.

The second end portion F2 of the safety tube band 110 is woven into the tube fabric and is flat woven. Additionally, the second end portion F2 of the safety tube band 110 is made of the first fiber yarn 111 as warp and the second fiber yarn 113 as weft. Additionally, the rubber yarns 115, 117 are arranged spaced apart from each other between the first fiber yarns 111 as warp. The first fiber yarn 111 and the rubber yarns 115, 117 that form the central portion C and the second end portion F2 of the safety tube band 110 are integrally extended. Accordingly, although not shown, in this embodiment, when three to eight first fiber yarns 111 arranged in parallel form a set of fiber yarns S, one or two rubber yarns 115, 117 may be repeatedly arranged in parallel between the sets of fiber yarns S. Preferably, three first fiber yarns 111 form a set of fiber yarns S, and one rubber yarn 115, 117 is repeatedly arranged in parallel between the sets of fiber yarns S.

Additionally, the tube fabric of the second end portion F2 of the safety tube band 110 is formed by weaving the first fiber yarn 111 as warp and the second fiber yarn 113 as weft together with the rubber yarns 115, 117. In this instance, the rubber yarns 115, 117 act as warp which is woven with the second fiber yarn 113 as weft.

As shown in FIG. 7, describing the interlaced structure of the second end portion F2 of the safety tube band 110, the rubber yarns 115, 117 that form the second end portion F2 of the safety tube band 110 include the first rubber yarn 115 as warp which is repeatedly woven with the second fiber yarn 113 as weft disposed in the upper fabric U of the tube fabric that forms the safety tube band 110 in an alternating manner, and the second rubber yarn 117 as warp which is repeatedly woven with the second fiber yarn 113 as weft disposed in the lower fabric D of the tube fabric that forms the safety tube band 110 in an alternating manner. The first rubber yarn 115 and the second rubber yarn 117 are woven with the first fiber yarn 111 and the second fiber yarn 113 by repeating the above-described process to form the flat second end portion F2 of the safety tube band 110. That is, the first rubber yarn 115 that forms the upper fabric U of the tube fabric that forms the safety tube band 110 is extended and repeatedly woven with the second fiber yarn 113 as weft disposed in the upper fabric U in an alternating manner, and the second rubber yarn 117 that forms the lower fabric D of the tube fabric that forms the safety tube band 110 is extended and repeatedly woven with the second fiber yarn 113 as weft disposed in the lower fabric D in an alternating manner. Meanwhile, the first rubber yarn 115 and the second rubber yarn 117 are woven in 70 to 90% stretched state of the total stretched length.

Additionally, while the second end portion F2 of the safety tube band 110 is woven as described above, the core material 130 made of the plurality of POY 131 is disposed inside the second end portion F2 of the safety tube band 110. Additionally, when the weaving of the second end portion F2 of the safety tube band 110 is completed, the second end portion F2 of the core material 130 protrudes out of the second end portion F2 of the safety tube band 110.

Additionally, the end of the second end portion F2 of the plurality of POY 131 is pulled in the arrow direction of FIG. 7 so that the length of the safety tube band 110 is longer than the total stretched length of the plurality of POY 131, and with the relative movement of the second end portion F2 of the safety tube band 110 toward the central portion C of the safety tube band 110, the end of the second end portion F2 of the plurality of POY 131 is pulled out of the second end portion F2 of the safety tube band 110 to the predetermined length.

Additionally, the length of the plurality of POY 131 is adjusted to meet a variety of safety standards from all over the world, the second end portion F2 of the plurality of POY 131 is cut, and the second end portion F2 of the safety tube band 110 and the second end portion F2 of the core material 130 are combined together by sewing them.

Meanwhile, when the weaving of the combination is completed, the second end portion F2 of the combination where the second end portion F2 of the safety tube band 110 is combined with the second end portion F2 of the core material 130 is folded and sewn B to form the hook loop H2 which is attached to the hook 160 (see FIG. 2).

The shock mitigation and absorption operation of the shock-absorbing lanyard 100 according to the present disclosure, configured as described above, will be described below.

FIGS. 8 to 10 are operational diagrams showing the operation of the shock-absorbing lanyard according to the present disclosure.

In case of a fall, when shock loads are transmitted to the shock-absorbing lanyard 100 by the worker's weight and acceleration, the shock-absorbing lanyard 100 mitigates and absorbs the shocks applied to the worker and prevents the worker from falling.

As shown in FIG. 8, when the shock loads are transmitted to the shock-absorbing lanyard 100, the rubber yarns 115, 117 of the safety tube band 110 stretch in the longitudinal direction to mitigate and absorb the shocks applied to the worker. Additionally, the length of the safety tube band 110 is freely adjustable with the movement of the worker, so it is possible to improve convenience for the worker at areas of activities.

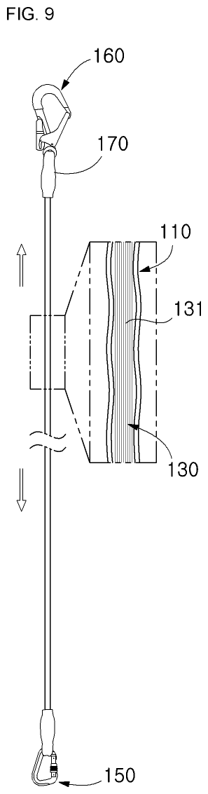

Additionally, as shown in FIG. 9, when additional shock loads are applied, the plurality of POY 131 of the core material 130 stretch in the longitudinal direction in a sequential order to mitigate and absorb the shocks applied to the worker.

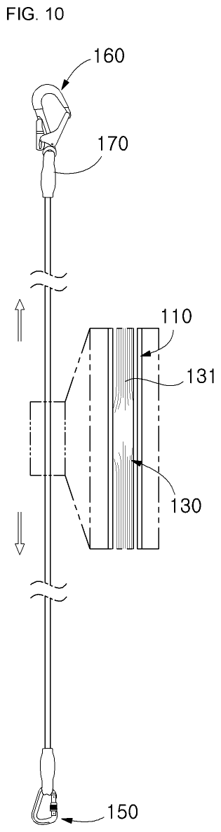

Additionally, as shown in FIG. 10, the safety tube band 110 may prevent the worker from falling even when the plurality of POY 131 of the core material 130 breaks due to too much shock loads.

The present disclosure is not limited to the disclosed embodiment, and it is obvious to those having ordinary skill in the technical field that a variety of modifications and changes may be made thereto without departing from the spirit and scope of the present disclosure. Accordingly, it should be understood that such modifications or changes fall in the scope of claims.

[Detailed Description of Main Elements]

| | |
|---|---|
| 100: Shock-absorbing lanyard | 110: Safety tube band |
| 111: First fiber yarn | 113: Second fiber yarn |
| 115: First rubber yarn | 117: Second rubber yarn |
| 130: Core material | 131: POY |
| 150: Carabiner | 160: Hook |
| 170: Protective cover | |

What is claimed is:

1. A method for manufacturing a shock-absorbing lanyard for easy length adjustment of partially oriented yarn (POY), comprising:
(a) weaving a safety tube band which is a tube fabric woven using fiber yarn and rubber yarn, and placing a core material in the safety tube band at the same time, wherein the core material is made of a plurality of POY and stretches in a longitudinal direction to absorb shock;
(b) adjusting a length of the core material after weaving the safety tube band; and
(c) combining the safety tube band with the core material to form a combination.

2. The method for manufacturing a shock-absorbing lanyard for easy length adjustment of POY according to claim 1, wherein the safety tube band includes:
a first end portion which is the tube fabric produced by weaving the fiber yarn and the rubber yarn as warp and the fiber yarn as weft and is flat in the longitudinal direction;
a central portion which is the tube fabric produced by weaving the fiber yarn as warp and weft and the rubber yarn as warp woven with the fiber yarn and as core yarn woven without the fiber yarn, repeatedly arranged at a predetermined interval, and is extended from the first end portion and corrugated in the longitudinal direction; and
a second end portion which is the tube fabric produced by weaving the fiber yarn and the rubber yarn as warp and the fiber yarn as weft, and is extended from the central portion and flat in the longitudinal direction, and wherein the step (a) comprises continuously weaving the first end portion, the central portion and the second end portion of the safety tube band in a sequential order.

3. The method for manufacturing a shock-absorbing lanyard for easy length adjustment of POY according to claim 2, wherein the rubber yarn which forms the central portion of the safety tube band includes:
first rubber yarn as warp which is woven over a plurality of the fiber yarns as weft disposed and continuously arranged in an upper fabric of the tube fabric which forms the safety tube band and interposed between the upper fabric and a lower fabric of the tube fabric which forms the safety tube band to a predetermined distance, wherein this process is repeatedly performed; and
second rubber yarn as warp which is woven under the plurality of fiber yarns as weft disposed and continuously arranged in the lower fabric of the tube fabric which forms the safety tube band and interposed between the upper fabric and the lower fabric of the tube fabric which forms the safety tube band to the predetermined distance, wherein this process is repeatedly performed.

4. The method for manufacturing a shock-absorbing lanyard for easy length adjustment of POY according to claim 3, wherein the first rubber yarn is woven over two to four fiber yarns as weft, and
wherein the second rubber yarn is woven under two or four fiber yarns as weft.

5. The method for manufacturing a shock-absorbing lanyard for easy length adjustment of POY according to claim 3, wherein three to eight fiber yarns arranged in parallel in the longitudinal direction form a set of fiber yarns, and
wherein one or two first rubber yarns or second rubber yarns are repeatedly arranged in parallel between the sets of fiber yarns.

6. The method for manufacturing a shock-absorbing lanyard for easy length adjustment of POY according to claim 3, wherein the first rubber yarn and the second rubber yarn are the core yarn interposed between the upper fabric and the lower fabric to the distance corresponding to an interval between ten to fifteen fiber yarns as weft.

7. The method for manufacturing a shock-absorbing lanyard for easy length adjustment of POY according to claim 6, wherein a first position and a second position repeat in an alternating manner along the longitudinal direction, the first position at which the first rubber yarn is woven over the plurality of fiber yarns as weft disposed in the upper fabric, and the second position at which the second rubber yarn is woven under the plurality of fiber yarns as weft disposed in the lower fabric.

8. The method for manufacturing a shock-absorbing lanyard for easy length adjustment of POY according to claim 3, wherein the first end portion and the second end portion of the safety tube band are flat woven by:
repeatedly weaving the first rubber yarn which forms the upper fabric with the fiber yarn as weft disposed in the upper fabric in an alternating manner, and
extending the second rubber yarn which forms the lower fabric and repeatedly weaving the second rubber yarn with the fiber yarn as weft disposed in the lower fabric in an alternating manner.

9. The method for manufacturing a shock-absorbing lanyard for easy length adjustment of POY according to claim 2, wherein the step (a) comprises weaving a first end portion of the plurality of POY of the core material with the first end portion of the safety tube band, and continuously weaving the central portion and the second end portion of the safety tube band in a sequential order, wherein the plurality of POY is arranged in parallel in the longitudinal direction inside the central portion and the second end portion of the safety tube band, and an end of a second end portion of the plurality of POY is disposed outside of the second end portion of the safety tube band.

10. The method for manufacturing a shock-absorbing lanyard for easy length adjustment of POY according to claim 9, wherein the step (b) comprises pulling the end of the second end portion of the plurality of POY out of the second end portion of the safety tube band, and cutting the second end portion of the plurality of POY so that a length of the safety tube band is longer than a total stretched length of the plurality of POY.

11. The method for manufacturing a shock-absorbing lanyard for easy length adjustment of POY according to claim 10, wherein the step (c) comprises sewing the second end portion of the safety tube band and the second end portion of the plurality of POY to form the combination.
